(19) United States
(12) Patent Application Publication
(10) Pub. No.: US 2026/0352286 A1
(43) Pub. Date: Nov. 5, 2026

(54) METHODS FOR SOUNDING REFERENCE SIGNAL (SRS)-AIDED CHANNEL STATE INFORMATION (CSI) FEEDBACK

(71) Applicant: InterDigital Patent Holdings, Inc., Wilmington, DE (US)

(72) Inventors: Ahmet Serdar Tan, London (GB); Yugeswar Deenoo Narayanan Thangaraj, Chalfont, PA (US); Mohamed Salah Ibrahim, Chesterbrook, PA (US); Anouar Yatribi, Greater London (GB)

(73) Assignee: InterDigital Patent Holdings, Inc., Wilmington, DE (US)

(21) Appl. No.: 19/198,368

(22) Filed: May 5, 2025

(51) Int. Cl. H04B 7/06; H04L 5/00

(52) U.S. Cl. CPC H04B 7/0626; H04B 7/06966; H04L 5/0048

(57) ABSTRACT

A wireless transmit/receive unit (WTRU) may comprise a processor configured to receive configuration information from a network. The configuration information may include a trigger associated with a channel state information (CSI)-linked sounding reference signal (SRS) transmission. The processor may be configured to determine CSI measurements based on received CSI-RS transmissions, determine to transmit the CSI-linked SRS transmission based on the trigger, determine one or more parameters for the CSI-linked SRS transmissions based on the CSI measurements and/or the received CSI-RS transmissions, send compressed CSI measurements to the network, and send a CSI-linked SRS transmission based on the one or more parameters.

### BACKGROUND

Channel state information (CSI) compression may focus on the compression of the CSI obtained through channel state information-reference signals (CSI-RS) received at the wireless transmit/receive unit (WTRU). CSI-RS and/or sounding reference signals (SRS) may show some degree of relationship in different scenarios

### SUMMARY

A wireless transmit/receive unit (WTRU) may comprise a processor. The processor may be configured to receive configuration information from a network. The configuration information may include, for example, a trigger associated with a channel state information (CSI)-linked sounding reference signal (SRS) transmission. The processor may be configured to determine CSI measurements based on received CSI-RS transmissions. The processor may be configured to determine to transmit the CSI-linked SRS transmission based on the trigger. The trigger may be associated with the CSI measurements and/or the received CSI-RS transmissions. The processor may be configured to determine one or more parameters for the CSI-linked SRS transmissions based on the CSI measurements and/or the received CSI-RS transmissions. The processor may be configured to send compressed CSI measurements to the network. In some examples, the compressed CSI measurements may be based on the CSI measurements. The processor may be configured to send a CSI-linked SRS transmission based on the one or more parameters. The one or more parameters may include, for example, timing and/or transmission parameters for the CSI-linked SRS transmission.

The configuration information may include, for example, a CSI-linked SRS configuration that indicates an association between CSI compression and SRS transmissions. In some examples, if association information is received then the WTRU may trigger the linked-SRS. In some examples, the WTRU may receive a plurality of CSI and/or SRS configurations. Without the linkage the WTRU may not trigger the appropriate SRS for given CSI-RS (e.g., if the linkage is not provided, the WTRU may assume that the SRS is not triggered based on the CSI-RS).

In some examples, the trigger may be based on a timing associated with the received CSI-RS transmissions and/or based on a timing of the transmission of the compressed CSI measurements to the network.

The configuration information may include, for example, a CSI-linked SRS transmission configuration. The processor may be configured to determine the one or more parameters based on the CSI-linked SRS transmission configuration. The one or more parameters may indicate time resources and/or frequency resources used for transmission of the CSI-linked SRS transmission. The CSI-linked SRS transmission configuration may include an offset. The processor may be configured to determine the one or more parameters based on the offset and resources used for the (e.g., received) CSI-RS transmissions, and/or resources used for transmission of the compressed CSI measurements.

The CSI-linked SRS transmission configuration may include, for example, an indication of a symbol and/or frequency domain position. The processor may be configured to determine the one or more parameters based on the indication of the symbol and frequency domain position and resources used for the (e.g., received) CSI-RS transmissions, and/or resources used for transmission of the compressed CSI measurements to the network.

The CSI-linked SRS transmission configuration may include, for example, an indication of antenna ports. The processor may be configured to determine the one or more parameters based on the indication of the antenna ports and antenna ports used for the (e.g., received) CSI-RS transmissions, and/or antenna ports used for transmission of the compressed CSI measurements to the network.

The processor may be configured to compress the determined CSI measurements to generate the compressed CSI measurements using an artificial intelligence or machine learning (AI/ML) compression model. The AI/ML compression model may include, for example, a two-sided autoencoder (AE) with an encoder and a decoder. The encoder may reside at the WTRU, and the decoder may reside at the network.

The WTRU may be configured to perform a method that includes one or more of the following steps. The method may include receiving configuration information from a network. The configuration information may include, for example, a trigger associated with a channel state information (CSI)-linked sounding reference signal (SRS) transmission. The method may include determining CSI measurements based on received CSI-RS transmissions. The method may include determining to transmit the CSI-linked SRS transmission based on the trigger. The trigger may be associated with the CSI measurements and/or the received CSI-RS transmissions. The method may include determining one or more parameters for the CSI-linked SRS transmissions based on the CSI measurements and/or the received CSI-RS transmissions. The method may include sending compressed CSI measurements to the network. In some examples, the compressed CSI measurements may be based on the CSI measurements. The method may include sending a CSI-linked SRS transmission based on the one or more parameters. The one or more parameters may include, for example, timing and/or transmission parameters for the CSI-linked SRS transmission.

The configuration information may include, for example, a CSI-linked SRS configuration that indicates an association between CSI compression and SRS transmissions. In some examples, if association information is received then the WTRU may trigger the linked-SRS. In some examples, the WTRU may receive a plurality of CSI and/or SRS configurations. Without the linkage the WTRU may not trigger the appropriate SRS for given CSI-RS (e.g., if the linkage is not provided, the WTRU may assume that the SRS is not triggered based on the CSI-RS).

In some examples, the trigger may be based on a timing associated with the received CSI-RS transmissions and/or based on a timing of the transmission of the compressed CSI measurements to the network.

The configuration information may include, for example, a CSI-linked SRS transmission configuration. The method may include determining the one or more parameters based on the CSI-linked SRS transmission configuration. The one or more parameters may indicate time resources and/or frequency resources used for transmission of the CSI-linked SRS transmission. The CSI-linked SRS transmission configuration may include an offset. The method may include determining the one or more parameters based on the offset and resources used for the (e.g., received) CSI-RS transmissions, and/or resources used for transmission of the compressed CSI measurements.

The CSI-linked SRS transmission configuration may include, for example, an indication of a symbol and/or frequency domain position. The method may include determining the one or more parameters based on the indication of the symbol and frequency domain position and resources used for the (e.g., received) CSI-RS transmissions, and/or resources used for transmission of the compressed CSI measurements to the network.

The CSI-linked SRS transmission configuration may include, for example, an indication of antenna ports. The method may include determining the one or more parameters based on the indication of the antenna ports and antenna ports used for the (e.g., received) CSI-RS transmissions, and/or antenna ports used for transmission of the compressed CSI measurements to the network.

The method may include compressing the determined CSI measurements to generate the compressed CSI measurements using an artificial intelligence or machine learning (AI/ML) compression model. The AI/ML compression model may include, for example, a two-sided autoencoder (AE) with an encoder and a decoder. The encoder may reside at the WTRU, and the decoder may reside at the network.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a system diagram illustrating an example SRS aided compressed CSI feedback according to an embodiment.

FIG. 3 is a flowchart illustrating an example procedure for SRS aided compressed CSI feedback according to an embodiment.

### DETAILED DESCRIPTION

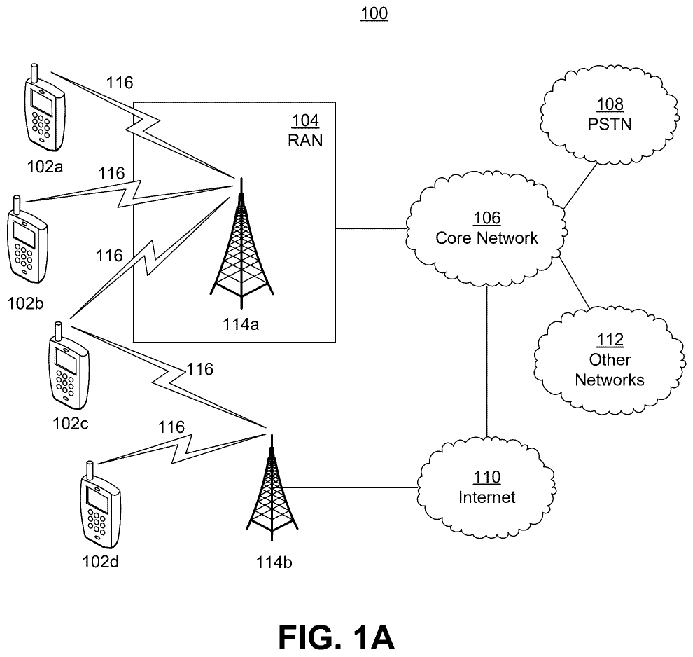

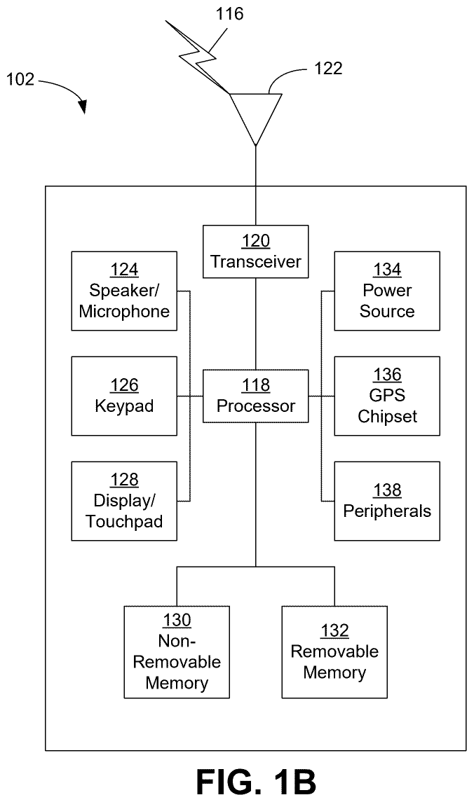

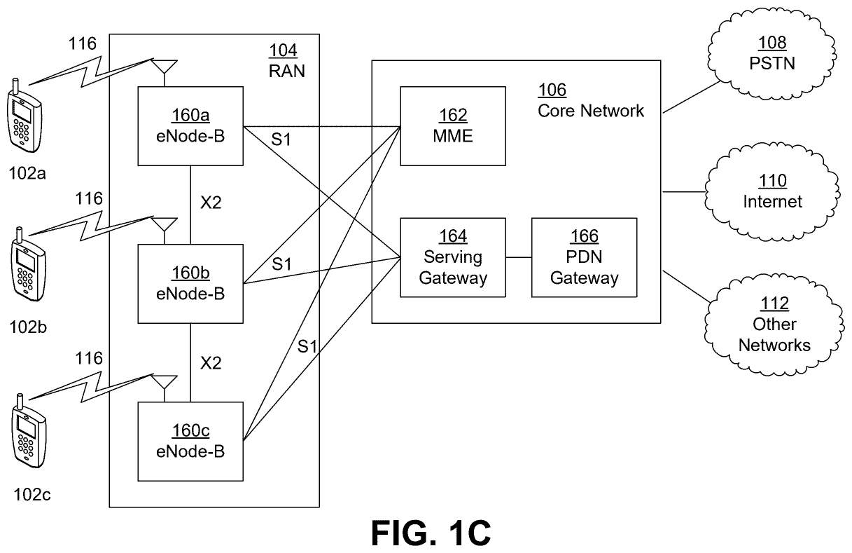

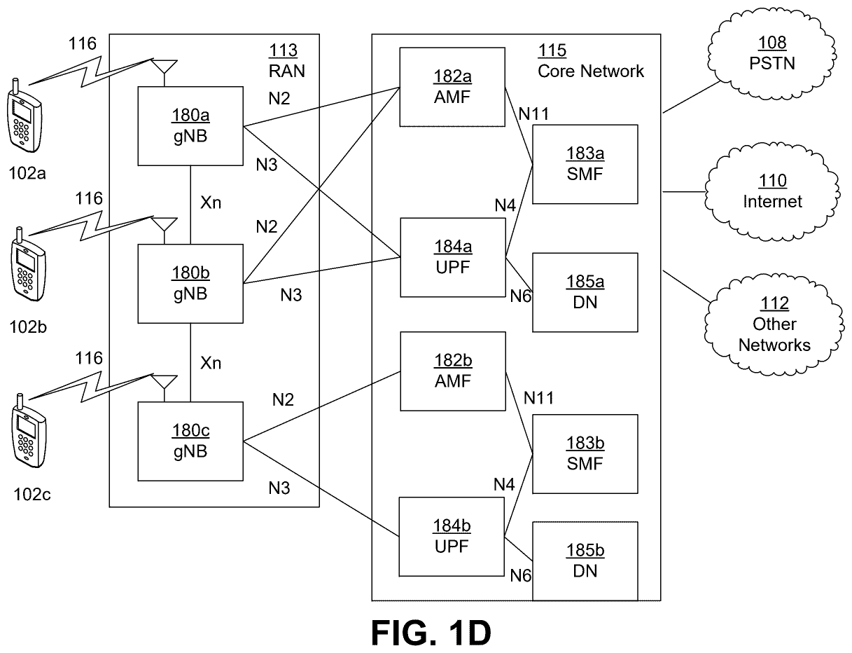

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A WTRU may be capable of sounding reference signal (SRS)-aided CSI compression. A WTRU may evaluate a SRS trigger condition and may determine a configuration for a linked SRS transmission as a function of a linked CSI feedback transmission and/or a linked CSI-RS transmission.

Artificial intelligence or machine learning (AI/ML)-based channel state information (CSI) compression may have been studied as a means to reduce the uplink (UL) CSI feedback reporting overhead for higher resolution downlink (DL) channel state information at the network (NW). The AI/ML-based CSI compression may use a two-sided autoencoder (AE) model, where the encoder part may be located at the transmitter (e.g., wireless transmit/receive unit (WTRU)) side and may compress the high dimensionality input data (e.g., CSI) to a lower dimensionality latent vector. The decoder part may be located at the receiver (e.g., NW) side and may perform the reconstruction based on the received latent vector (e.g., compressed CSI). The input to the autoencoder may be a channel matrix and/or a channel eigen vector obtained through processing the received CSI-RS signals.

SRS may be seen as an uplink equivalence to the downlink channel state information-reference signal (CSI-RS), where SRS is used to obtain CSI for an uplink channel. CSI-RS and/or SRS can serve as quasi-colocation (QCL) references. Given the knowledge of a suitable receiver beam for the CSI-RS, the same beam may be assigned to the SRS as well as other physical channels. CSI-RS and/or SRS may be configured separately. For example, the WTRU may receive separate configurations and resource sets for CSI-RS and/or SRS where both may be configured for periodic, semi-persistent and/or aperiodic transmission.

CSI compression may focus on the compression of the CSI obtained through CSI-RS signals received at the WTRU. CSI-RS and/or SRS signals may show some degree of reciprocity in different scenarios (e.g. in the FDD scheme), for example, in the angle-delay domain due to potential similarities in the angle of arrival (AoA) and/or angle of departure (AoD), speed, etc. The reciprocity between CSI-RS and/or SRS may lead to reduced CSI feedback overhead with AI/ML models (e.g., autoencoders) trained with channel information obtained from both CSI-RS and/or SRS. Mechanisms may be defined to enable SRS-aided CSI compression.

In some examples, a WTRU capable of SRS-aided CSI compression may evaluate SRS trigger conditions and may determine a configuration (e.g., configuration information) for a linked SRS transmission as a function of a linked CSI feedback transmission and/or linked CSI-RS transmission. The configuration may include, for example, one or more of the following. The configuration may include triggers for linked SRS transmission (e.g., triggered by CSI-RS reception and/or CSI feedback transmission). The configuration may include the timing of SRS transmission (e.g., at a time offset from CSI feedback or time offset from a linked CSI-RS transmission). The configuration may include availability of resources for SRS transmission (e.g., as a function of type of CSI feedback). The configuration may include resources for SRS transmission (e.g., relative to the physical uplink control channel (PUCCH)/physical uplink shared channel (PUSCH) resource used for CSI feedback transmission and/or the slot containing the CSI-RS resource). The configuration may include the CSI compression model (e.g., based on the linked SRS configuration). The configuration may include a CSI-linked SRS configuration that may indicate an association between CSI compression and SRS transmissions. In some examples, if association information is received then the WTRU may trigger the linked-SRS. In some examples, the WTRU may receive a plurality of CSI and/or SRS configurations. Without the linkage the WTRU may not trigger the appropriate SRS for given CSI-RS (e.g., if the linkage is not provided, the WTRU may assume that the SRS is not triggered based on the CSI-RS).

In some examples, a WTRU capable of SRS-aided CSI compression may receive one or more of the following configurations from the network (NW). For example, a WTRU capable of SRS-aided CSI compression may receive CSI-linked-SRS configuration. CSI-linked-SRS configuration may include, for example, CSI compression. CSI-linked-SRS configuration may include link to CSI report configuration ID and/or CSI-RS resource configuration ID in case of CSI compression usage.

In some examples, a WTRU capable of SRS-aided CSI compression may receive configurations on CSI-linked-SRS trigger. Configurations on CSI-linked-SRS trigger may include, for example, rules on triggering CSI-linked-SRS based on the CSI feedback report timing. Configurations on CSI-linked-SRS trigger may include rules on triggering based on associated and/or linked CSI-RS reception. Configurations on CSI-linked-SRS trigger may include rules on triggering based on dropped CSI feedback.

In some examples, a WTRU capable of SRS-aided CSI compression may receive configuration on CSI-linked-SRS transmission timing and resources (e.g., transmission configuration). Configuration on CSI-linked-SRS transmission timing and resources may be based on, for example, CSI feedback timing (e.g., an offset from UL resource carrying CSI-feedback, wherein the offset can be negative, positive, or zero). Configuration on CSI-linked-SRS transmission timing and resources may be based on, for example, CSI-RS timing (e.g., an offset from DL resource carrying CSI-RS). Configuration on CSI-linked-SRS transmission timing and resources may include, for example, starting symbol and frequency domain position of SRS relative to the CSI-RS and/or CSI-feedback. Configuration on CSI-linked-SRS transmission timing and resources may be based on, for example, the prediction window (e.g., timing predicted CSI instance). Configuration on CSI-linked-SRS transmission timing and resources may be based on, for example, the WTRU being configured to select antenna ports for SRS based on received CSI-RS and/or configured CSI feedback resources.

In some examples, a WTRU capable of SRS-aided CSI compression may receive configurations on CSI prediction timing. For example, the WTRU may be configured to determine the CSI prediction timing based on a parameter of the configured CSI-linked-SRS.

In some examples, a WTRU capable of SRS-aided CSI compression may receive configurations on CSI model selection. Configurations on CSI model selection may include, for example, a first AI/ML model and/or a first compression ratio and a second AI/ML model and/or a second compression ratio. For instance, the second AI/ML model and/or compression ratio may have a smaller overhead than the first AI/ML model and/or compression ratio. Configurations on CSI model selection may include, for example, the WTRU receiving model parameters and/or identifiers from NW (e.g., one or more models for SRS-aided CSI compression and one or model for non-SRS-aided CSI compression, and/or one or more models for CSI prediction).

In some examples, the WTRU may receive CSI-RS and measures CSI. In some examples, the WTRU may trigger transmission of CSI-linked-SRS based on CSI-linked-SRS configuration, CSI-RS reception and/or CSI feedback transmission. For example, the WTRU may trigger transmission if the WTRU received CSI-RS linked to an SRS. The WTRU may trigger transmission if the WTRU is scheduled with CSI feedback resources to report compressed CSI with second model. In some examples, if the WTRU drops the linked CSI feedback, then the WTRU may drop linked SRS if configured to skip SRS, trigger linked SRS if configured to send SRS, and/or trigger linked SRS with new resources if configured.

In some examples, the WTRU may determine one or more parameters of the CSI-linked-SRS (e.g., timing and transmission resources) based on CSI-linked-SRS configuration, CSI-RS reception and/or CSI feedback transmission. For example, the WTRU may determine slot timing based on a configured offset from UL resources for CSI feedback (e.g., the WTRU may determine the slot timing for linked SRS transmission by adding the configured offset to the configured CSI feedback slot). The WTRU may determine slot timing based on a configured offset from the DL resources used for CSI-RS (e.g., the WTRU may determine the slot timing for linked SRS transmission by adding the configured offset to the received CSI-RS slot). The WTRU may determine slot timing based on the timing of predicted CSI (e.g., the WTRU may determine the slot timing relative to the slot timing of the predicted CSI and/or the WTRU may determine the same slot for the SRS timing as the timing of predicted CSI). The WTRU may determine symbol and/or frequency resources relative to the symbols and/or frequency resources of CSI feedback (e.g., the WTRU may determine the symbols of the SRS by adding an offset to the first symbol of CSI feedback resources, and/or the WTRU may determine the frequency resources of SRS by adding an offset to the lowest/highest frequency resources of the CSI feedback). The WTRU may determine antenna ports based on the linked CSI-RS and/or configured CSI feedback resources (e.g., the WTRU may transmit SRS on a subset of linked CSI-RS antenna ports that has highest received RSRP, and/or the WTRU may choose the complement of CSI feedback antenna ports).

In some examples, the WTRU may compress the CSI of the received CSI-RS. For example, the WTRU may compress the received CSI-RS based on whether CSI-linked-SRS is triggered to be transmitted and/or the parameters of the triggered CSI-linked-SRS. For instance, the WTRU may select a model for CSI compression based on CSI-linked-SRS configuration. If the received CSI-RS has an associated and/or linked SRS configuration, then the WTRU may select a second AI/ML model and/or a second compression ratio for CSI compression. If the received CSI-RS does not have an associated and/or linked SRS configuration, the WTRU may select a first AI/ML model and/or a first compression ratio for CSI compression.

In some examples, the WTRU may transmit compressed CSI feedback through an uplink channel (e.g., PUSCH and/or PUCCH). In some examples, the WTRU may transmit the CSI-linked-SRS based on the determined configurations. In some examples, a WTRU capable of SRS aided CSI compression and/or related methods described herein may achieve lower compressed CSI feedback overhead.

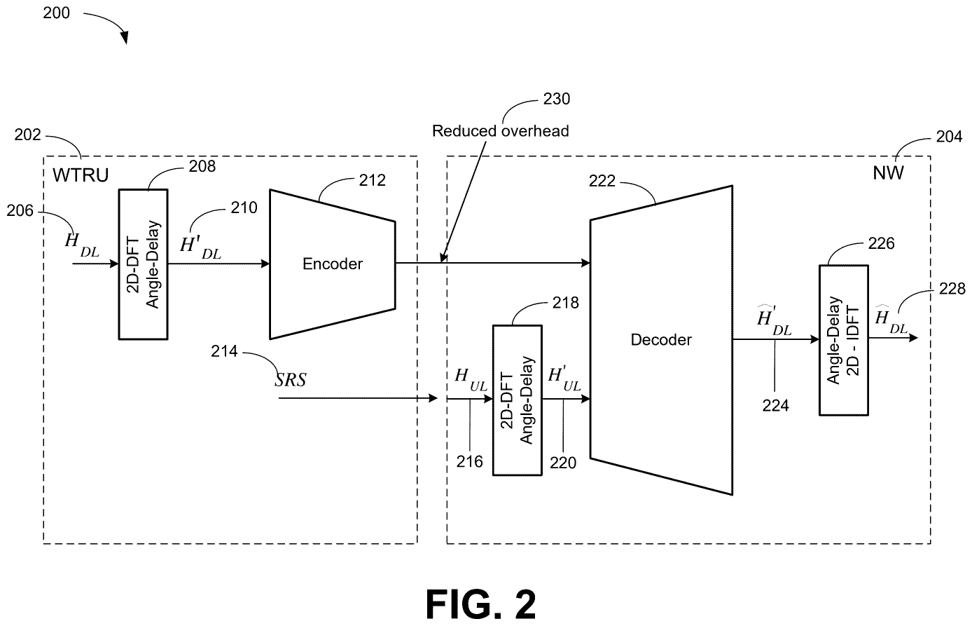

FIG. 2 is a system diagram 200 illustrating an example SRS aided compressed CSI feedback. In some examples, a WTRU capable of SRS-aided CSI compression may use the example mechanism as illustrated in system diagram 200, for example, to exploit the potential channel reciprocity between downlink and uplink channels wherein the reciprocity may be more pronounced in the angle-delay domain representation of the channel. The WTRU may use pre-and/or post processing to transform the channel state information to angle-delay domain using two dimensional discrete Fourier transform (2D-DFT) and/or two dimensional inverse discrete Fourier transform (2D-IDFT). The example mechanism as illustrated in system diagram 200 may be applicable to both frequency division duplex (FDD) and time division duplex (TDD) configurations.

In system diagram 200, H_{DL} 206 corresponds to the measured CSI at the WTRU 202 for received CSI-RS, and H′_{DL} 210 corresponds to the angle-delay domain transform 208 of H_{DL} 206. At the NW side 204, H_{UL} 216 corresponds to the measured uplink channel for received SRS 214, and H′_{UL} 220 corresponds to the angle-delay domain transform 218 of H_{UL}, Ĥ′_{DL} 224 corresponds to reconstructed (decompressed) H′DL 210, and Ĥ_{DL} 228 corresponds to reconstructed H_{DL} 206.

A WTRU capable of SRS-aided CSI compression and feedback may receive one or more of the following configurations from the NW.

In some examples, the WTRU may receive configurations on the CSI-linked-SRS for the type of SRS. For example, the WTRU may receive a configuration for type and/or usage of SRS wherein the configuration may indicate the type and/or usage as CSI compression or uplink channel sounding. If the configured SRS type and/or usage is CSI compression, for example, the WTRU may receive configuration on the link between CSI-RS and/or SRS. The WTRU may receive a configuration indicating the link in between CSI-RS and/or SRS, wherein for the link for example, the WTRU may receive an associated CSI-RS resource configuration ID for each SRS configuration. If the configured SRS type and/or usage is CSI compression, for example, the WTRU may receive a configuration indicating the link between CSI report and SRS, wherein the WTRU may receive associated CSI report configuration ID for each SRS configuration.

In some examples, the WTRU may receive configurations on the triggers for CSI-linked-SRS, wherein the configuration may include one or more of the following. For example, the WTRU may receive rules on triggering CSI-linked SRS based on the CSI feedback report timing (e.g., if the WTRU is configured with SRS linked to CSI report, and/or when to trigger CSI-linked SRS based on CSI feedback report timing). The WTRU may receive rules on triggering CSI-linked SRS based on the CSI-RS reception (e.g., if the WTRU is configured with SRS linked to CSI-RS resources). The WTRU may receive rules on triggering CSI report based on the CSI-linked SRS (e.g., if the WTRU is configured with SRS linked to CSI report). The WTRU may receive rules on sending and/or dropping the linked SRS based on whether compressed CSI feedback is dropped.

In some examples, the WTRU may receive configurations for the timing and/or resources on CSI-linked SRS transmission based on one or more of the following. For example, the WTRU may receive configurations for the timing and/or resources on CSI-linked SRS transmission based on CSI feedback timing (e.g., if SRS is linked to CSI report, the WTRU may receive an offset from UL resource carrying CSI-feedback, wherein the offset may be negative, positive, or zero). The WTRU may receive configurations for the timing and/or resources on CSI-linked SRS transmission based on CSI-RS timing (e.g., if SRS is linked to CSI-RS, the WTRU may receive an offset from DL resource carrying CSI-RS). The WTRU may receive configurations for the timing and/or resources on CSI-linked SRS transmission based on the symbols and/or frequency domain position of SRS relative to the CSI-RS and/or CSI-feedback, (e.g., the WTRU may receive an offset value relative to CSI-RS resources and/or CSI-feedback). In some examples, if the WTRU is configured for CSI prediction, timing of linked-SRS transmission may be based on the prediction window (e.g., based on the timing of predicted CSI instance, the WTRU may receive an offset value relative to the CSI prediction timing). In some examples, the WTRU may be configured to select antenna ports for SRS based on received CSI-RS and/or configured CSI feedback resources (e.g., based on the measurements on the received signal).

In some examples, the WTRU may be configured to determine CSI prediction based on the configurations of CSI-linked-SRS. For example, the WTRU may receive configurations on determining the CSI prediction timing based on the timing of the CSI-linked-SRS transmission. For example, the WTRU may receive an offset value relative to the timing of CSI-linked-SRS wherein the offset may be negative, positive or zero.

In some examples, the WTRU may be configured to determine the CSI compression model based on the type of SRS. For example, the WTRU may be configured with a first AI/ML model and/or a first compression ratio and a second AI/ML model and/or a second compression ratio, wherein the second AI/ML model and/or compression ratio has a smaller overhead than the first AI/ML model and/or compression ratio. For example, the WTRU may be configured to select a second AI/ML model if the type and/or usage of SRS is CSI compression, otherwise the WTRU may be configured to select a first AI/ML model. In some examples, the WTRU may further receive model parameters and/or identifiers from the NW (e.g., one or more models for SRS-aided CSI compression and one or model for non-SRS-aided CSI compression, and/or one or more models for CSI prediction).

In some examples, the WTRU may determine one or more parameters and/or triggers for SRS transmission based on a linked-CSI-RS configuration. For example, the WTRU may determine one or more parameters and/or triggers for SRS transmission based on a linked CSI feedback configuration.

In some examples, the WTRU may be configured with a link between a first SRS resource and a first CSI reference signal (CSI-RS). In some examples, the WTRU may trigger SRS transmission upon reception of a linked CSI Reference Signal. The WTRU may receive configuration of periodic CSI-RS in radio resource control (RRC) signaling. The WTRU may trigger SRS transmission upon reception of RRC configuration containing periodic CSI-RS configuration and SRS configuration. In some examples, the WTRU may trigger SRS transmission upon reception of periodic CSI-RS. For example, the WTRU may be configured with semi-persistent CSI-RS reception based on activation command from medium access control-control element (MAC-CE). The WTRU may trigger SRS transmission upon reception of MAC-CE activating semi-persistent reception of a linked CSI-RS. In another example, the WTRU may trigger SRS transmission upon reception of semi-persistent CSI-RS. The WTRU may stop SRS transmission upon reception of MAC-CE deactivating semi-persistent reception of a linked CSI-RS. In some examples, the WTRU may be configured for aperiodic CSI-RS reception based on indication in downlink control information (DCI). The WTRU may trigger SRS transmission upon reception of DCI triggering aperiodic reception of a linked CSI-RS. The WTRU may trigger SRS transmission upon reception of a linked aperiodic CSI-RS. The WTRU may stop SRS transmission linked to aperiodic CSI-RS after one shot SRS transmission.

In some examples, the WTRU may be configured with a link between a first SRS resource and a first CSI reporting configuration. In some examples, the WTRU may trigger SRS transmission based upon transmission of a linked CSI feedback. The CSI feedback may be triggered based on the first CSI reporting configuration. In some examples, the WTRU may trigger SRS transmission when linked CSI feedback is triggered. The resources and/or timing for SRS transmission may be relative to the linked CSI feedback transmission. The WTRU may be configured to trigger SRS transmission periodically wherein the SRS periodicity may be defined as a function (e.g., multiple) of CSI feedback periodicity. The WTRU may receive configuration of periodic CSI reporting in RRC signaling. In some examples, the WTRU may trigger SRS transmission upon reception of RRC configuration containing SRS configuration and a linked periodic CSI reporting configuration. In some examples, the WTRU may be configured with semi-persistent CSI feedback reporting on PUCCH or PUSCH. The semi-persistent CSI feedback may be triggered based on activation command from MAC-CE. The WTRU may trigger SRS transmission upon reception of MAC-CE activating semi-persistent transmission of a linked CSI feedback. In another example, the WTRU may trigger SRS transmission upon reporting of semi-persistent CSI feedback. The WTRU may stop SRS transmission upon reception of MAC-CE deactivating semi-persistent CSI feedback reporting. In another example, the WTRU may be configured for aperiodic CSI feedback reporting based on indication in DCI. The WTRU may trigger SRS transmission upon reception of DCI triggering aperiodic reporting of CSI feedback. In some examples, the WTRU may trigger SRS transmission upon transmission of linked CSI feedback. The WTRU may stop SRS transmission linked to aperiodic CSI report after one shot CSI feedback transmission.

In some examples, the WTRU may be configured with a first AI/ML model and a second AI/ML model for CSI compression. The WTRU may receive an indication that the CSI feedback from the second AI model is linked to SRS transmission. The first AI/ML model may be associated with a standalone CSI feedback compression. The second AI/ML model may be associated with an SRS-aided CSI feedback compression. The AI/ML may be configured to trigger SRS transmission when the CSI feedback is generated via the second AI/ML model. The WTRU may be configured to trigger SRS transmission when the AI/ML model for CSI feedback is switched from first AI/ML model to second AI/ML model. The WTRU may be configured to skip the SRS transmission when the CSI feedback is generated via the first AI model. The WTRU may be configured to skip the SRS transmission when the WTRU falls back to legacy CSI feedback from AI/ML CSI feedback.

In some examples, the WTRU may drop the CSI feedback based on one or more conditions. For example, the WTRU may drop the CSI feedback when the CPU occupancy exceeds the WTRU capability. For example, the WTRU may drop the CSI feedback when the UL resources are not available for CSI feedback transmission. For example, the WTRU may drop the CSI feedback when the CSI feedback is lower priority compared to other CSI feedback, uplink control channel (UCI) and/or UL transmissions. In some examples, if the WTRU drops CSI feedback, the WTRU may perform one or more preconfigured actions on the linked-SRS transmission. For example, the WTRU may skip the linked SRS transmission if the CSI feedback is dropped. Additionally and/or alternatively, the WTRU may transmit the linked SRS if the CSI feedback is dropped. For example, the WTRU may transmit SRS in a first set of resources if the linked-CSI feedback is transmitted. The WTRU may transmit SRS in a second set of resources if the linked-CSI feedback is dropped. In some examples, upon trigger of SRS transmission, the WTRU may transmit SRS on the resources determined by methods described below and herein.

In some examples, the WTRU may determine one or more configuration and/or triggers for CSI feedback based on a linked SRS configuration. In some examples, the WTRU may be configured with a link between a first SRS resource and a first CSI reporting configuration. For example, the WTRU may trigger CSI feedback reporting based upon the configuration of a linked SRS. The WTRU may trigger CSI feedback reporting when linked SRS transmission is triggered. The resources and/or timing for CSI feedback reporting may be relative to the linked SRS transmission. The WTRU may be configured to trigger CSI reporting periodically wherein the CSI feedback periodicity may be defined as a function (e.g., multiple) of SRS transmission periodicity. The WTRU may receive configuration of periodic SRS transmission in RRC signaling. For example, the WTRU may trigger CSI feedback report upon reception of RRC configuration containing SRS configuration and a linked periodic CSI reporting configuration. In some examples, the WTRU may be configured with semi-persistent SRS transmission. The semi-persistent SRS transmission may be triggered based on an activation command from MAC-CE. The WTRU may trigger CSI feedback reporting upon reception of MAC-CE activating semi-persistent linked SRS transmission. In some examples, the WTRU may trigger CSI feedback reporting upon semi-persistent SRS transmission. The WTRU may stop CSI feedback reporting upon reception of MAC-CE deactivating semi-persistent SRS transmission. For example, the WTRU may be configured for aperiodic SRS transmission based on indication in DCI. The WTRU may trigger CSI feedback reporting upon reception of DCI triggering aperiodic SRS transmission. In some examples, the WTRU may trigger CSI feedback reporting upon transmission of linked SRS. The WTRU may stop CSI feedback reporting linked to aperiodic SRS transmission after one shot SRS transmission.

In some examples, the WTRU may be configured to send a compressed CSI (e.g., generated using a WTRU-sided encoder model), together with SRS, to be used for CSI reconstruction (e.g., using a NW-sided decoder model). The decoder model may use the compressed CSI along with a function of the transmitted and/or received SRS to generate the CSI reconstruction part. Herein, the term CSI-linked-SRS may be used to indicate the association and/or linkage between CSI and SRS to ensure proper operation of the SRS-aided CSI compression framework.

In some examples, the WTRU may be configured to determine one or more parameters associated with the CSI-linked-SRS, wherein the parameters may include at least one of the timing and transmission resources. In some examples, the timing parameter may be used to indicate the timing between the CSI-RS reception and the SRS transmission. The timing parameter may be used to indicate the timing between the CSI feedback transmission report and the SRS transmission. The timing parameter may be used to indicate the timing between one or more predicted CSI and the SRS transmission. The terms timing, slot timing and SRS timing may be used interchangeably to indicate the timing and/or time-slot associated with the SRS transmission.

In some examples, the WTRU may be configured and/or indicated to determine the SRS timing based on the CSI-linked-SRS configuration. For example, the WTRU may determine the slot timing based on a configured offset from configured UL resources for CSI feedback. The offset may be a function of the configured uplink resources for CSI feedback. For example, a WTRU may determine a first offset associated with a first UL resource configuration for CSI feedback and a second offset associated with a second UL resource configuration for CSI feedback. In some examples, the WTRU may determine the slot timing for linked SRS transmission by adding the offset to the configured UL resources for CSI feedback. The WTRU may determine the slot timing based on a configured offset from the downlink (DL) resources used for CSI-RS. In some examples, the offset may be a function of the configured downlink resources for CSI-RS. For example, a WTRU may determine a first offset associated with a first DL resource configuration for CSI-RS and a second offset associated with a second DL resource configuration for CSI-RS. In some examples, the WTRU may determine the slot timing for linked SRS transmission by adding the offset to the configured DL resources for CSI-RS. For example, the WTRU may determine the slot timing based on a configured offset from a specific CSI prediction instance. A WTRU may determine a time offset measured relative to the slot timing of the predicted CSI. In some examples, the offset may be zero wherein the SRS may be transmitted at the same slot of the predicted CSI. The offset may be positive indicating that the SRS transmission may occur at the predicted slot time in addition to the offset. The offset may be negative indicating that the SRS transmission may occur at predicted slot minus the offset.

In some examples, the WTRU may be configured and/or indicated to determine the SRS transmission resources based on the CSI-linked-SRS configuration. For example, the WTRU may determine the time and/or frequency resources based on a configured offset from configured UL resources for CSI feedback. In some examples, the time offset may be determined relative to the first and/or last symbol for CSI feedback. The frequency offset may be determined relative to the lowest and/or highest frequency of the CSI feedback. In some examples, the UL resources for SRS may be obtained using a defined, fixed function, and/or mapping of the CSI feedback configured resources. For example, the SRS resources for CSI-linked-SRS may be explicitly indicated through DCI and/or MAC-CE.

In some examples, the WTRU may determine the SRS antenna ports as a function of the quality of the received CSI-RS at all receive antenna ports. For example, the WTRU may determine a first set of transmit antenna ports and a second set of transmit antenna ports, wherein the measured reference signal received power (RSRP) on the first set is higher than the measured RSRP on the second set. The WTRU may use the first set of transmit antenna ports for transmission if the number of transmit antenna ports is configured to be less than the number of receive antenna ports. For example, a WTRU configured for SRS antenna switching with a number of SRS transmit antenna ports is less than the number of receive antenna ports may select the transmit antenna ports with the highest signal-to-noise ratio (SNR), RSRP, and/or signal-to-interference plus noise ratio (SINR).

In some examples, a WTRU may compute a predicted CSI, if configured, according to the linked SRS configuration. In some examples, a WTRU may predict CSI at the configured CSI-linked-SRS timing, for example when the WTRU is configured to match the timing of SRS for CSI feedback. In this example, the WTRU may need to collect a buffer of CSI samples for the observation window in order to perform CSI prediction wherein the prediction timing matches the SRS timing. In some examples, if prediction timing is not configured, the WTRU may not predict any future CSI.

In some examples, the WTRU may determine an AI/ML-based CSI prediction timing based on one or more configured offset(s). For example, the configuration may include an offset (e.g., delta) defined before or after CSI-linked-SRS. In another example, multiple offsets may be defined based on one or more of the WTRU's applicable conditions (e.g., WTRU speed, time-domain channel property (TDCP), etc.). In one example, one or more offset(s) may be configured by the NW. In another example, the offsets may be determined by AI/ML model capability. In another example, the offset(s) may be determined by the WTRU, for example based on coherence time, and/or TDCP.

In some examples, if the WTRU is configured to compress and report more than one predicted CSI, then WTRU may determine the timing of predicted CSI based on the CSI-linked-SRS (e.g., the timing of one of the CSI prediction instances may match the timing of CSI-linked-SRS transmission). In another example, the timing of one of the CSI prediction instances may match the timing of CSI-linked-SRS transmission with an offset. The WTRU may receive a configuration and/or indication of the index of CSI prediction instance to match the timing of CSI-linked-SRS.

In some examples, for the determination of a CSI compression model, the WTRU may determine a AI/ML model to select for CSI compression depending on whether the received CSI-RS has an associated and/or linked SRS configuration. In one example, if the CSI-linked-SRS is triggered to be transmitted, the WTRU may determine and/or select a second AI/ML model for CSI compression (e.g., an AI/ML model that supports SRS as a side information input (at the decoder side), and/or a second compression ratio). For example, a second compression ratio may be received in the configuration, corresponding to the situation where SRS is supported at the decoder side, wherein a second compression ratio is relatively higher as reconstruction performance is compensated at the NW side, using the transmitted CSI-linked-SRS. In another example, the WTRU may be configured with one or more models supporting CSI-linked-SRS, and/or a second AI/ML model may be defined as a set of AI/ML models (e.g., same AI/ML model architecture) but with different compression ratios.

In some examples, if the WTRU has received a CSI-RS with no associated and/or linked SRS configuration, the WTRU may select a first AI/ML model and/or a first compression ratio, wherein a first AI/ML model is not supporting a linked SRS as a side information at the decoder side.

In some examples, the WTRU may receive a first and a second AI/ML model from the NW, wherein the first AI/ML model may be associated with compressed CSI feedback without linked-SRS, and the second AI/ML model may be associated with compressed CSI feedback with linked-SRS. The WTRU may receive a first set of model parameters of a first encoder for the first AI/ML model and a second set of parameters of a second encoder for the second AI/ML model.

In some examples, the WTRU may receive indication to train a CSI compression model for compressing the CSI with CSI-linked-SRS as the side information at the decoder. For the purpose of training the model, for example, the WTRU may receive one or more sets of data including measured CSI (e.g., measured CSI at the WTRU), compressed CSI (e.g., the output of the encoder) and/or measured CSI-linked-SRS (e.g., uplink channel measurements of CSI-linked-SRS collected at the NW). In this example, the WTRU may train both the encoder and/or decoder associated with a second AI/ML model. In another example, the WTRU may receive one or more sets of data including measured CSI and/or compressed CSI, wherein the compressed CSI may be associated with an autoencoder model with side information as CSI-linked-SRS. In this example, the WTRU may train an encoder associated with a second AI/ML model.

In some examples, the WTRU may transmit the compressed CSI feedback through an uplink channel based on configuration (e.g., PUSCH and/or PUCCH). If the CSI feedback is associated with an SRS, then the CSI feedback may occupy less overhead compared to the CSI feedback with no associated SRS.

In some examples, the WTRU may transmit the CSI-linked SRS based on the determined configurations, wherein the configurations may include the timing, frequency and/or antenna resources for the SRS transmission. The WTRU may determine to drop and/or send the CSI-linked-SRS based on whether the linked compressed CSI feedback is dropped. In one example, the WTRU may skip the CSI-linked-SRS if CSI feedback is dropped. In another example, the WTRU may send the CSI-linked-SRS even if CSI feedback is dropped. In another example, the WTRU may send the CSI-linked-SRS in a new set of resources, if the CSI feedback is dropped.

In some examples, the WTRU may report the type of reported CSI feedback, wherein the type may indicate whether the CSI report was generated with a first model that does not include CSI-linked-SRS at the NW, and/or whether the CSI report was generated with a second model that may include CSI-linked-SRS at the NW. For example, the WTRU may feedback the report with a binary value (e.g., where 0 may indicate a CSI report without CSI-linked-SRS and 1 may indicate a CSI report associated with CSI-linked-SRS).

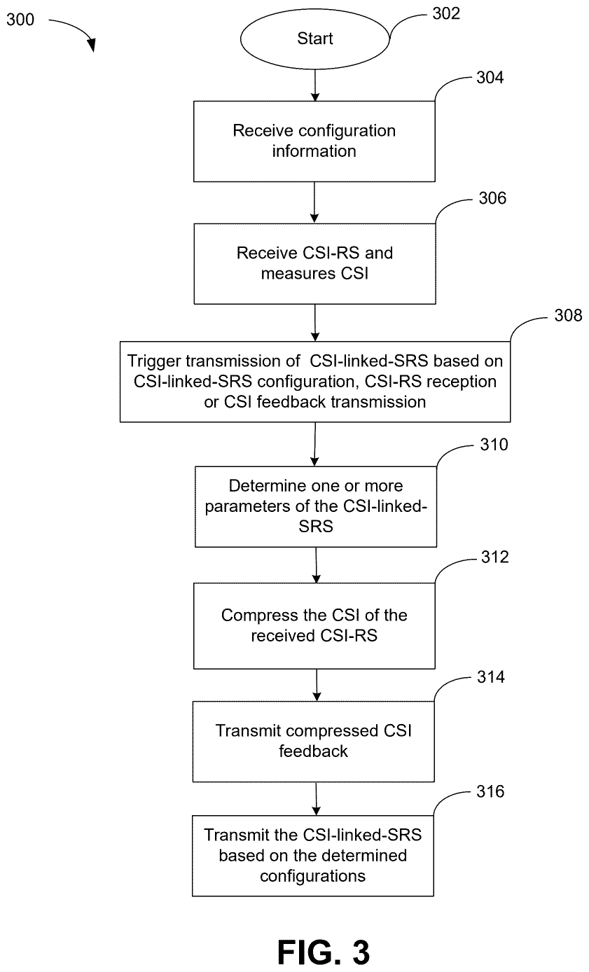

FIG. 3 is an example of a procedure 300 for SRS-aided CSI compression. The procedure 300 may be performed by a WTRU. The procedure 300 may start at 302. At 304, a WTRU capable of SRS-aided CSI compression may receive one or more of the following configurations from the NW. For example, a WTRU capable of SRS-aided CSI compression may receive CSI-linked-SRS configuration. CSI-linked-SRS configuration may include, for example, CSI compression. CSI-linked-SRS configuration may include link to CSI report configuration ID and/or CSI-RS resource config ID in case of CSI compression usage.

In some examples, a WTRU capable of SRS-aided CSI compression may receive configurations on CSI-linked-SRS trigger. Configurations on CSI-linked-SRS trigger may include, for example, rules on triggering CSI-linked-SRS based on the CSI feedback report timing. Configurations on CSI-linked-SRS trigger may include rules on triggering based on associated and/or linked CSI-RS reception. Configurations on CSI-linked-SRS trigger may include rules on triggering based on dropped CSI feedback.

In some examples, a WTRU capable of SRS-aided CSI compression may receive configuration on CSI-linked-SRS transmission timing and resources (e.g., transmission configuration). Configuration on CSI-linked-SRS transmission timing and resources may be based on, for example, CSI feedback timing (e.g., an offset from UL resource carrying CSI-feedback, wherein the offset can be negative, positive, or zero). Configuration on CSI-linked-SRS transmission timing and resources may be based on, for example, CSI-RS timing (e.g., an offset from DL resource carrying CSI-RS). Configuration on CSI-linked-SRS transmission timing and resources may include, for example, starting symbol and frequency domain position of SRS relative to the CSI-RS and/or CSI-feedback. Configuration on CSI-linked-SRS transmission timing and resources may be based on, for example, the prediction window (e.g., timing predicted CSI instance). Configuration on CSI-linked-SRS transmission timing and resources may be based on, for example, the WTRU being configured to select antenna ports for SRS based on received CSI-RS and/or configured CSI feedback resources.

In some examples, a WTRU capable of SRS-aided CSI compression may receive configurations on CSI prediction timing. For example, the WTRU may be configured to determine the CSI prediction timing based on a parameter of the configured CSI-linked-SRS.

In some examples, a WTRU capable of SRS-aided CSI compression may receive configurations on CSI model selection. Configurations on CSI model selection may include, for example, a first AI/ML model and/or a first compression ratio and a second AI/ML model and/or a second compression ratio. For instance, the second AI/ML model and/or compression ratio may have a smaller overhead than the first AI/ML model and/or compression ratio. Configurations on CSI model selection may include, for example, the WTRU receiving model parameters and/or identifiers from NW (e.g., one or more models for SRS-aided CSI compression and one or model for non-SRS-aided CSI compression, and/or one or more models for CSI prediction).

At 306, the WTRU may receive CSI-RS and measures CSI. At 308, the WTRU may trigger transmission of CSI-linked-SRS based on CSI-linked-SRS configuration, CSI-RS reception and/or CSI feedback transmission. For example, the WTRU may trigger transmission if the WTRU received CSI-RS linked to an SRS. The WTRU may trigger transmission if the WTRU is scheduled with CSI feedback resources to report compressed CSI with second model. In some examples, if the WTRU drops the linked CSI feedback, then the WTRU may drop linked SRS if configured to skip SRS, trigger linked SRS if configured to send SRS, and/or trigger linked SRS with new resources if configured.

At 310, the WTRU may determine one or more parameters of the CSI-linked-SRS (e.g., timing and transmission resources) based on CSI-linked-SRS configuration, CSI-RS reception and/or CSI feedback transmission. For example, the WTRU may determine slot timing based on a configured offset from UL resources for CSI feedback (e.g., the WTRU may determine the slot timing for linked SRS transmission by adding the configured offset to the configured CSI feedback slot). The WTRU may determine slot timing based on a configured offset from the DL resources used for CSI-RS (e.g., the WTRU may determine the slot timing for linked SRS transmission by adding the configured offset to the received CSI-RS slot). The WTRU may determine slot timing based on the timing of predicted CSI (e.g., the WTRU may determine the slot timing relative to the slot timing of the predicted CSI and/or the WTRU may determine the same slot for the SRS timing as the timing of predicted CSI). The WTRU may determine symbol and/or frequency resources relative to the symbols and/or frequency resources of CSI feedback (e.g., the WTRU may determine the symbols of the SRS by adding an offset to the first symbol of CSI feedback resources, and/or the WTRU may determine the frequency resources of SRS by adding an offset to the lowest/highest frequency resources of the CSI feedback). The WTRU may determine antenna ports based on the linked CSI-RS and/or configured CSI feedback resources (e.g., the WTRU may transmit SRS on a subset of linked CSI-RS antenna ports that has highest received RSRP, and/or the WTRU may choose the complement of CSI feedback antenna ports).

At 312, the WTRU may compress the CSI of the received CSI-RS. For example, the WTRU may compress the received CSI-RS based on whether CSI-linked-SRS is triggered to be transmitted and/or the parameters of the triggered CSI-linked-SRS. For instance, the WTRU may select a model for CSI compression based on CSI-linked-SRS configuration. If the received CSI-RS has an associated and/or linked SRS configuration, then the WTRU may select a second AI/ML model and/or a second compression ratio for CSI compression. If the received CSI-RS does not have an associated and/or linked SRS configuration, the WTRU may select a first AI/ML model and/or a first compression ratio for CSI compression.

At 314, the WTRU may transmit compressed CSI feedback through an uplink channel (e.g., PUSCH and/or PUCCH). At 316, the WTRU may transmit the CSI-linked-SRS based on the determined configurations.

1. A wireless transmit/receive unit (WTRU) comprising:
a processor configured to:
receive configuration information from a network, wherein the configuration information comprises a trigger associated with a channel state information (CSI)-linked sounding reference signal (SRS) transmission;
determine CSI measurements based on received CSI-RS transmissions;
determine to transmit the CSI-linked SRS transmission based on the trigger, wherein the trigger is associated with the CSI measurements or the received CSI-RS transmissions;
determine one or more parameters for the CSI-linked SRS transmissions based on the CSI measurements or the received CSI-RS transmissions;
send compressed CSI measurements to the network, wherein the compressed CSI measurements are based on the CSI measurements; and
send a CSI-linked SRS transmission based on the one or more parameters.

2. The WTRU of claim 1, wherein the one or more parameters comprises timing or transmission parameters for the CSI-linked SRS transmission.

3. The WTRU of claim 1, wherein the configuration information comprises a CSI-linked SRS configuration that indicates an association between CSI compression and SRS transmissions.

4. The WTRU of claim 1, wherein the trigger is based on a timing associated with the received CSI-RS transmissions or based on a timing of the transmission of the compressed CSI measurements to the network.

5. The WTRU of claim 1, wherein the configuration information comprises a CSI-linked SRS transmission configuration; and
wherein the processor is configured to determine the one or more parameters based on the CSI-linked SRS transmission configuration, wherein the one or more parameters indicate time resources or frequency resources used for transmission of the CSI-linked SRS transmission.

6. The WTRU of claim 5, wherein the CSI-linked SRS transmission configuration comprises an offset; and
wherein the processor is configured to determine the one or more parameters based on the offset and (i) resources used for the received CSI-RS transmissions or (ii) resources used for transmission of the compressed CSI measurements.

7. The WTRU of claim 5, wherein the CSI-linked SRS transmission configuration comprises an indication of a symbol and frequency domain position; and
wherein the processor is configured to determine the one or more parameters based on the indication of the symbol and frequency domain position and (i) resources used for the received CSI-RS transmissions or (ii) resources used for transmission of the compressed CSI measurements to the network.

8. The WTRU of claim 5, wherein the CSI-linked SRS transmission configuration comprises an indication of antenna ports; and
wherein the processor is configured to determine the one or more parameters based on the indication of the antenna ports and (i) antenna ports used for the received CSI-RS transmissions or (ii) antenna ports used for transmission of the compressed CSI measurements to the network.

9. The WTRU of claim 1, wherein the processor is configured to compress the determined CSI measurements to generate the compressed CSI measurements using an artificial intelligence or machine learning (AI/ML) compression model.

10. The WTRU of claim 9, wherein the AI/ML compression model comprises a two-sided autoencoder (AE) with an encoder and a decoder, wherein the encoder resides at the WTRU, and the decoder resides at the network.

11. A method performed by a wireless transmit/receive unit (WTRU), the method comprising:
receiving configuration information from a network, wherein the configuration information comprises a trigger associated with a channel state information (CSI)-linked sounding reference signal (SRS) transmission;
determining CSI measurements based on received CSI-RS transmissions;
determining to transmit the CSI-linked SRS transmission based on the trigger, wherein the trigger is associated with the CSI measurements or the received CSI-RS transmissions;
determining one or more parameters for the CSI-linked SRS transmissions based on the CSI measurements or the received CSI-RS transmissions;
sending compressed CSI measurements to the network, wherein the compressed CSI measurements are based on the CSI measurements; and
sending a CSI-linked SRS transmission based on the one or more parameters.

12. The method of claim 11, wherein the one or more parameters comprises timing or transmission parameters for the CSI-linked SRS transmission.

13. The method of claim 11, wherein the configuration information comprises a CSI-linked SRS configuration that indicates an association between CSI compression and SRS transmissions.

14. The method of claim 11, wherein the trigger is based on a timing associated with the received CSI-RS transmissions or based on a timing of the transmission of the compressed CSI measurements to the network.

15. The method of claim 11, wherein the configuration information comprises a CSI-linked SRS transmission configuration; and
wherein the method further comprises determining the one or more parameters based on the CSI-linked SRS transmission configuration, wherein the one or more parameters indicate time resources or frequency resources used for transmission of the CSI-linked SRS transmission.

16. The method of claim 15, wherein the CSI-linked SRS transmission configuration comprises an offset; and
wherein the method further comprises determining the one or more parameters based on the offset and (i) resources used for the received CSI-RS transmissions or (ii) resources used for transmission of the compressed CSI measurements.

17. The method of claim 15, wherein the CSI-linked SRS transmission configuration comprises an indication of a symbol and frequency domain position; and
wherein the method further comprises determining the one or more parameters based on the indication of the symbol and frequency domain position and (i) resources used for the received CSI-RS transmissions or (ii) resources used for transmission of the compressed CSI measurements to the network.

18. The method of claim 15, wherein the CSI-linked SRS transmission configuration comprises an indication of antenna ports; and
wherein the method further comprises determining the one or more parameters based on the indication of the antenna ports and (i) antenna ports used for the received CSI-RS transmissions or (ii) antenna ports used for transmission of the compressed CSI measurements to the network.

19. The method of claim 11, wherein the method further comprises compressing the determined CSI measurements to generate the compressed CSI measurements using an artificial intelligence or machine learning (AI/ML) compression model.

20. The method of claim 19, wherein the AI/ML compression model comprises a two-sided autoencoder (AE) with an encoder and a decoder, wherein the encoder resides at the WTRU, and the decoder resides at the network.
